(19) United States
(12) Patent Application Publication
(10) Pub. No.: US 2022/0233891 A1
(43) Pub. Date: Jul. 28, 2022

(54) Rope-Lowering Device and Corresponding Lowering Method

(71) Applicants: Hendrik Nieuwenhuis, Bleiswijk (NL); Cornelis Jan Nieuwenhuis, Bleiswijk (NL); Hendrik Christian Verdoold, Stolwijk (NL)

(72) Inventors: Hendrik Nieuwenhuis, Bleiswijk (NL); Cornelis Jan Nieuwenhuis, Bleiswijk (NL); Hendrik Christian Verdoold, Stolwijk (NL)

(21) Appl. No.: 17/611,300

(22) PCT Filed: May 15, 2020
(86) PCT No.: PCT/NL2020/050314

§ 371 Date: Nov. 15, 2021

(30) Foreign Application Priority Data
May 15, 2019 (NL) 2023145

(51) Int. Cl. A62B 1/10; A62B 1/18; B66D 1/26; B66D 1/60

(52) U.S. Cl. CPC A62B 1/10; A62B 1/18; B66D 2700/07; B66D 1/60; B66D 1/26

(57) ABSTRACT

The invention relates to a rope-lowering device for lowering persons from a building or the like, comprising: an axle arranged to rotate about its longitudinal axis; a first reel connected or connectable to the axle; a second reel connected or connectable to the axle; a brake connected to the axle, which brake is configured to provide a braking force to the axle independent of a direction of rotation; a first rope connected to the first reel to be suspended from the first reel; and a second rope connected to the second reel to be suspended from the second reel, wherein the rope-lowering device is configured such that when both the first and second reels are connected to the axle, paying out one of the first and second rope will automatically cause the other one of the first and second rope to be hauled in.

### BACKGROUND OF THE INVENTION

The invention relates to a rope-lowering device for lowering persons from a building or the like, e.g. also including structures like ski lifts, wind turbines, towers, etc., for instance in case of a calamity such as a fire. The invention further relates to a corresponding lowering method.

Rope-lowering devices are well-known and typically include:
an axle arranged to rotate about its longitudinal axis;
a reel connected to the axle;
a rope connected to the reel to be suspended from the reel; and
a brake connected to the axle, which brake is configured to provide a braking force when paying out the rope.

Such rope-lowering devices can be used to lower persons from a building, e.g. in case of a calamity such as a fire. Person may be trapped in the building, e.g. due to fire and smoke and may only be able to leave the building safely via a window or balcony. However, even from relatively small heights, jumping of a building may cause serious harm upon impact with the ground.

Rope-lowering devices may be connected to the building, permanently or temporarily in case of an emergency, and a person may use the rope to lower said person from the building. When the rope is paid out from the reel, the brake will ensure that the lowering speed of the person remains within limits so that the impact with the ground is reduced and the chance of the person reaching the ground safely is increased.

However, a disadvantage of the current devices is that for the next person to use the device to lower the person from the building, the rope needs to be hauled in first. This consumes valuable time and energy.

### SUMMARY OF THE INVENTION

In view of the above it is an object of the invention to provide a rope-lowering device which allows to quickly lower a plurality of persons from a building in case of an emergency.

The object of the invention is achieved by a rope-lowering device for lowering persons from a building or the like, comprising:
an axle arranged to rotate about its longitudinal axis;
a first reel connected or connectable to the axle;
a second reel connected or connectable to the axle;
a brake connected to the axle, which brake is configured to provide a braking force to the axle independent of a direction of rotation;
a first rope connected to the first reel to be suspended from the first reel; and
a second rope connected to the second reel to be suspended from the second reel,

wherein the rope-lowering device is configured such that when both the first and second reels are connected to the axle, paying out one of the first and second rope will automatically cause the other one of the first and second rope to be hauled in.

It is explicitly mentioned here that the term “rope” needs to be interpreted broadly as being any kind of elongated flexible element with tensile strength that can be wound on a reel and is able to carry the weight of a person suspended from the rope-lowering device. Hence, it may include cords, strings, twines, bands and be made of any kind of material including but not limited to metal, plastics, fabrics or other yarns, fibers or strands. The rope may further include elements twisted or braided together.

In an embodiment, the first reel has a disconnected state, in which the axle is free to rotate relative to the first reel, and a connected state, in which the first reel is connected to the axle to rotate along with the axle. Preferably, a retainer is provided to temporarily retain the first reel in the disconnected state. Preferably, a spring is provided to move the first reel towards the connected state upon release from the retainer. However, other elements urging the first reel towards the connected state and/or keep the first reel in the connected state may be provided, e.g. permanent magnets.

In an embodiment, the first reel has a coupling element and the axle has a coupling element to couple with the coupling element of the first reel in a connected state. Preferably, the coupling element of the first reel and the corresponding coupling element on the axle are configured such that the coupling is stronger in a rotational direction corresponding to paying out the first rope than in the opposite rotational direction.

In an embodiment, the second reel has a disconnected state, in which the axle is free to rotate relative to the second reel, and a connected state, in which the second reel is connected to the axle to rotate along with the axle. Preferably, a retainer is provided to temporarily retain the second reel in the disconnected state. Preferably, a spring is provided to move the second reel towards the connected state upon release from the retainer. However, other elements urging the second reel towards the connected state and/or keep the second reel in the connected state may be provided, e.g. permanent magnets.

In an embodiment, the retainer to temporarily retain the first or second reel in the disconnected state is releasable from the respective first or second reel by rotating the respect first or second reel over a predetermined angle, preferably smaller than 360 degrees, more preferably smaller than 180 degrees and most preferably smaller than 90 degrees, for instance smaller than 45 degrees, between a retaining orientation and a releasing orientation. For instance, in the retaining orientation, a shoulder may be present on the first or second reel to cooperate with a hook element on the retainer, while in the releasing orientation, no shoulder may be present for the retainer to cooperate with, thereby releasing the first or second reel. In between the retaining orientation and the releasing orientation, the should may gradually disappear.

In an embodiment, rotating the first or second reel causes a mechanism, e.g. a cam mechanism, or a simple cord or similar device, to operate on the retainer thereby moving the retainer to a releasing position in which the retainer is no longer connected to the first or second reel, thereby allowing the first or second reel to move to the connected state.

In an embodiment, the retainer has a predetermined strength and is connected between the first or second reel and another element of the device, e.g. a frame or the axle, such that when a predetermined load is applied to the first or second reel, the retainer is broken or damaged thereby releasing the first or second reel from the retainer or the other element of the device.

In an embodiment, the retainer is a permanent magnet cooperating with ferromagnetic material on the first or second reel. The other way around with the retainer being ferromagnetic material and the permanent magnet being provided on the first or second reel is also possible. Rotating the first or second reel relative to the retainer may then rotate the ferromagnetic material and the permanent magnet out of engagement thereby releasing the first or second reel from the retainer.

In an embodiment, the second reel has a coupling element and the axle has a coupling element to couple with the coupling element of the second reel in a connected state. Preferably, the coupling element of the second reel and the corresponding coupling element on the axle are configured such that the coupling is stronger in a rotational direction corresponding to paying out the second rope than in the opposite rotational direction, e.g. due to a sawtooth pattern on the coupling elements that mesh with each other.

In an embodiment, the rope-lowering device comprises a frame for supporting the other components of the rope-lowering device and to withstand the loads applied to the rope-lowering device during lowering of persons. The frame preferably includes two end members and one or more cross beams interconnecting the two end members. Further, the frame may include a brake housing to accommodate the brake, which brake housing may be connected to the one or more cross beams. Depending on the application, one or more reinforcement elements, e.g. rods, may be provided, for instance extending between the two end members and possibly connected to the brake housing as well or extending between an end member and the brake housing.

In an embodiment, the rope-lowering device further comprises a cover to limit access to the device, which cover is preferably configured to be supported by the frame.

In an embodiment, the device, e.g. the frame and/or cover, are provided with a fixation device to fix the device to a building or any other construction.

In an embodiment, the axle is rotatably supported by the two end members of the frame, preferably using corresponding bearings between the axle and the end members.

In an embodiment, the brake is configured to apply an increasing braking force with increasing speed, e.g. lowering speed of the first and/or second rope.

In an embodiment, the brake is a centrifugal brake, e.g. with a stationary part being connected to the frame, e.g. via the brake housing, and a moveable part being connected to the axle.

In an embodiment, the brake is or comprises a rotary damper in which energy is dissipated to limit the lowering speed to a safe range for a wide variety of persons. For instance, the rotary damper is a hydraulic damper, e.g. a hydraulic damper in which hydraulic fluid is forced through one or more orifices to provide sufficient resistance to rotational movement. Dissipation may also occur in the form of eddy currents or electrical dissipation in one or more resistors.

In an embodiment, the first and/or second reel are permanently connected or coupled to the axle, for instance by being integral with the axle or by being permanently in the connected state using the aforementioned coupling elements. An advantage of the earlier described coupling, preferably having a strong and weak coupling direction, is that the respective reel may still be allowed to slip in predetermined cases, for example when both ropes are wound on the respective reels and one of the rope and reel combination is used for a first lowering. The other rope and reel combination may then be allowed to slip to keep the rope and reel combination in place.

In an embodiment, the length of first rope and the length of second rope is at least 3 meters, preferably at least 5 meters, more preferably at least 10 meters and most preferably at least 25 meters.

In an embodiment, the brake is configured to limit the fall speed for a person weighing 80 kg to at most 30 km/h, preferably to at most 25 km/h, more preferably to at most 20 km/h, most preferably to at most 15 km/h, e.g. to at most 10 km/h.

The invention also relates to a method for lowering persons from a building or the like, wherein use is made of a rope-lowering device according to the invention, said method comprising the following steps:
a. connecting a first person to the first rope;
b. lowering the first person;
c. disconnecting the first person from the first rope;
d. connecting a second person to the second rope;
e. lowering the second person; and
f. disconnecting the second person from the second rope,

wherein during step e. the first rope is automatically hauled in.

In an embodiment, the method further comprises the following steps:
g. connecting a next person to the first or second rope previously hauled in;
h. lowering the next person; and
i. disconnecting the next person from said first or second rope,

wherein during step h. the other one of the first and second rope is automatically hauled in, and wherein preferably the steps g. to i. are repeated until all persons have been lowered that need to be lowered.

In an embodiment, the second reel of the rope-lowering device has a disconnected state, in which the axle is free to rotate relative to the second reel, and a connected state, in which the second reel is connected to the axle to rotate along with the axle, wherein prior to step a. the second reel is brought into the disconnected state, and wherein during step d. or e. the second reel is brought into the connected state.

In an embodiment, the first reel of the rope-lowering device has a disconnected state, in which the axle is free to rotate relative to the first reel, and a connected state, in which the first reel is connected to the axle to rotate along with the axle, wherein prior to step a. the first reel is brought into the disconnected state, and wherein during step a. or b. the first reel is brought into the connected state.

The invention further relates to a method for refurbishing a rope-lowering device according to the invention after being used, said method comprising the step of:
a. winding the first and/or second rope on the respective first and/or second reel.

In an embodiment, the first reel of the rope-lowering device has a disconnected state, in which the axle is free to rotate relative to the first reel, and a connected state, in which the first reel is connected to the axle to rotate along with the axle, and wherein the method includes the step of:
b. providing the first reel in the disconnected state.

In an embodiment, the second reel of the rope-lowering device has a disconnected state, in which the axle is free to rotate relative to the second reel, and a connected state, in which the second reel is connected to the axle to rotate along with the axle, and wherein the method includes the step of:
c. providing the second reel in the disconnected state.

In an embodiment, the method includes the step of carrying out maintenance to the brake, e.g. by replacing worn parts or portions.

Although reference is made to the lowering of persons, it will be apparent that the same device and methods can be used to lower objects.

### BRIEF DESCRIPTION OF THE DRAWINGS

The invention will now be described in a non-limiting way with reference to the accompanying drawings in which like parts are indicated by like reference symbols, and in which:

FIG. 1 schematically depicts a perspective view of a rope-lowering device according to an embodiment of the invention;

FIG. 2 schematically depicts front view of the rope-lowering device of FIG. 1;

FIG. 3 schematically depicts a top view of the rope-lowering device of FIG. 1;

FIG. 4 schematically depicts a side view of the rope-lowering device of FIG. 1;

FIG. 5 schematically depicts a cross-sectional view of the rope-lowering device of FIG. 1 according to line A-A as shown in FIG. 4;

FIG. 6 schematically depicts a perspective view of a first or second reel of the rope-lowering device of FIG. 1;

FIG. 7 schematically depicts a perspective view of a locking ring of the rope-lowering device of FIG. 1;

FIG. 8 schematically depicts a building equipped with a rope-lowering device according to the invention;

FIG. 9 schematically depicts the lowering of a first person from the building of FIG. 8;

FIG. 10 schematically depicts the first person reaching the ground after being lowered from the building of FIG. 8;

FIG. 11 schematically depicts the lowering of a second person from the building of FIG. 8;

FIG. 12 schematically depicts the second person reaching the ground after being lowered from the building of FIG. 8;

FIG. 13 schematically depicts a portion of a rope-lowering device according to another embodiment of the invention; and

FIG. 14 schematically depicts a retainer for the rope-lowering device of FIG. 13.

### DETAILED DESCRIPTION OF THE INVENTION

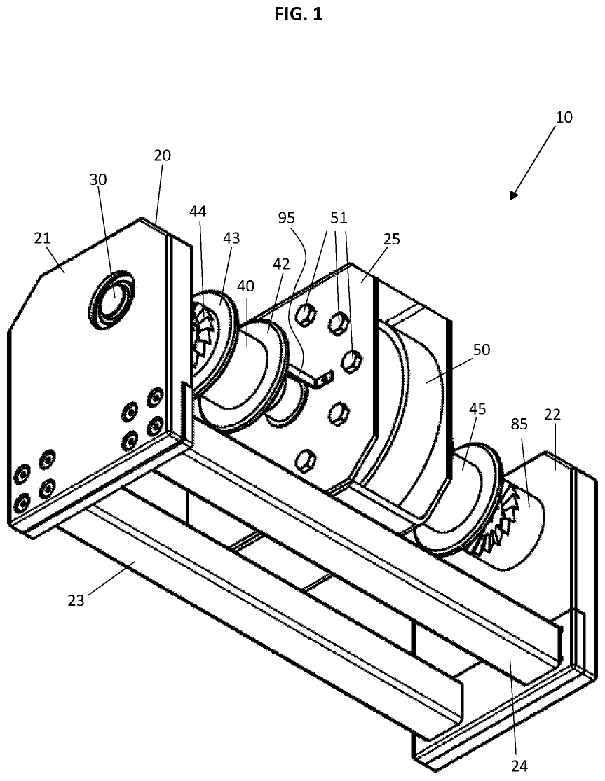

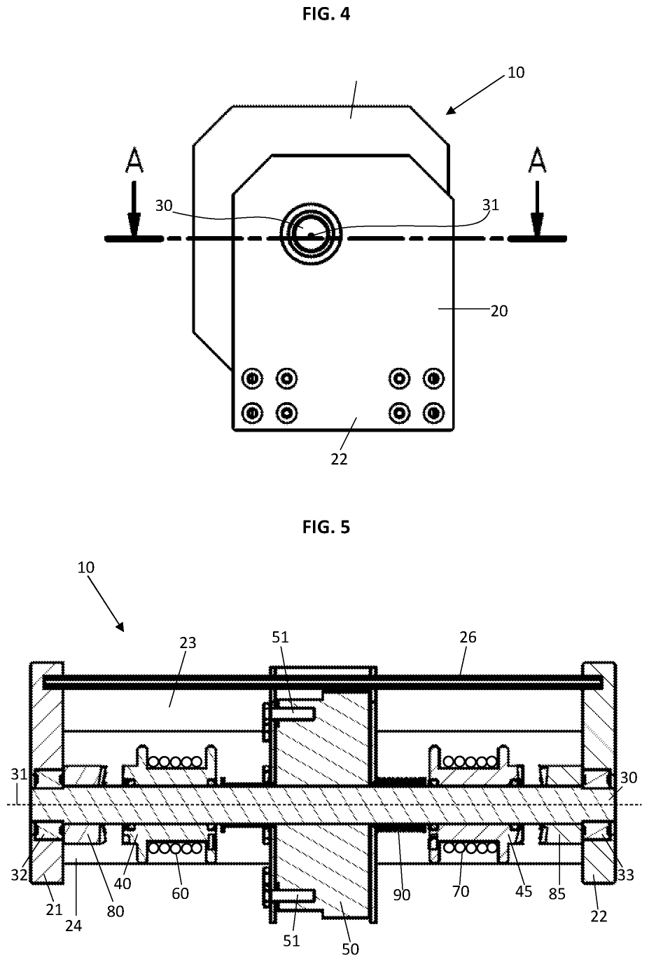

FIGS. 1-5 schematically depict a rope-lowering device 10 according to an embodiment of the invention. FIGS. 1-4 depict a perspective view, a front view, a top view, and a side view of the rope-lowering device 10, respectively. In FIG. 4, a line A-A is shown indicating a plane used for the cross-sectional view of the rope-lowering device 10 as shown in FIG. 5.

The rope-lowering device 10 is intended and suitable for lowering persons for instance from a building or the like, e.g. including ski lifts, wind turbines, towers, etc., in case of an emergency when other exits cannot be used, e.g. due to a fire, flood or obstructions. However, the rope-lowering device 10 can also be used in other applications such as for instance lowering people into a cave.

The rope-lowering device 10 includes a frame 20, which frame 20 in this embodiment comprises:
two end members 21, 22;
two cross beams 23, 24 interconnecting the two end members 21, 22;
a brake housing 25 connected to the two cross beams; and
a reinforcement rod 26 extending between the two end members 21, 22 and through the brake housing 25.

The frame 20 is constructed to provide a rigid frame for supporting the other components of the rope-lowering device 10 that will be explained below and to withstand the loads applied to the rope-lowering device 10 during lowering of persons. The frame 20 is preferably also configured to support a cover (not shown), which cover is designed to shield the interior of the rope-lowering device 10 thereby e.g. preventing persons from entering the interior and interfere with or get stuck in moveable components of the device 10 and/or shield the interior from weather influences such as rain or dust.

The frame 20 and/or cover may further be equipped with a fixation device (not shown) to fix the device 10 to the building or any other construction. The fixation device may for instance be an eye or hook to cooperate with another hook. This allows to temporarily fix the device 10 to the building or other construction in case of an emergency only, but the fixation device may also provide for a more (semi-)permanent fixation to the building or other construction, so that the device 10 is ready to be used anytime.

Supported by the frame 20, the rope-lowering device 10 comprises:
an axle 30 arranged to rotate about its longitudinal axis 31;
a first reel 40;
a second reel 45;
a brake 50 connected to the axle 30 and to the brake housing 25, which brake 50 is configured to provide a braking force to the axle 30 independent of a direction of rotation of the axle 30 about its longitudinal axis 31;
a first rope 60 connected to the first reel 40 to be suspended from the first reel 40; and
a second rope 70 connected to the second reel 45 to be suspended from the second reel 45.

The first and second rope 60, 70 have only been depicted in FIG. 5 in an initial state in which both ropes 60, 70 are wound on the respective reel 40, 45. The first and second rope 60, 70 have been omitted from FIGS. 1-4 for clarity reasons.

As can be clearly seen in FIG. 5, the axle 30 is rotatably supported by the two end members 21, 22 of the frame 20 via bearings 32, 33. In this embodiment, the axle 30 has a constant cross-section over the entire length of the axle 30, but this is not necessary per se.

The brake 50 in this embodiment a centrifugal brake, meaning that rotation of the axle connected to the brake will apply centrifugal forces to friction pads causing them to move outwards against a drum or housing to apply a braking force upon touching the drum or housing. An advantage of this type of brake is that the braking force is independent of the direction of rotation and the brake limits the rotational speed of the axle 30 so that the speed with which the persons are lowered is also limited ensuring a smooth landing. The drum or housing of the brake 50 is connected to the brake housing 25 of the frame using bolts 51 as shown in the figures, although not all bolts are indicated using reference numeral 51.

Although in this embodiment, the brake 50 is a frictional brake using an explicit wear surface, it may also be another type of brake, including but not limited to a hydrodynamic brake using friction in a working fluid, a pumping brake using pumping losses for braking, or an electromagnetic brake, e.g. using electromagnetic induction or eddy currents. Further, the brake may be a rotary damper, e.g. a hydraulic damper in which vanes are rotated through the housing and hydraulic fluid is forced through orifices in the vanes or between the vanes and the housing to provide sufficient resistance and thus braking force.

The first and second reel 40, 45 can be permanently connected to the axle 30. In an embodiment, the reels may be integral with the axle 30, e.g. when a cylindrical portion is defined on the axle 30 to receive the first or second rope, for instance using two flanges on the axle 30. However, in the embodiment of FIGS. 1-5, the first and second reel 40, 45 are connectable to the axle 30, so that the first and second reel 40, 45 have a disconnected state in which the axle 30 is free to rotate relative to the respective reel and a connected state in which the axle 30 is connected to the respective reel such that the reel rotates along with the axle 30.

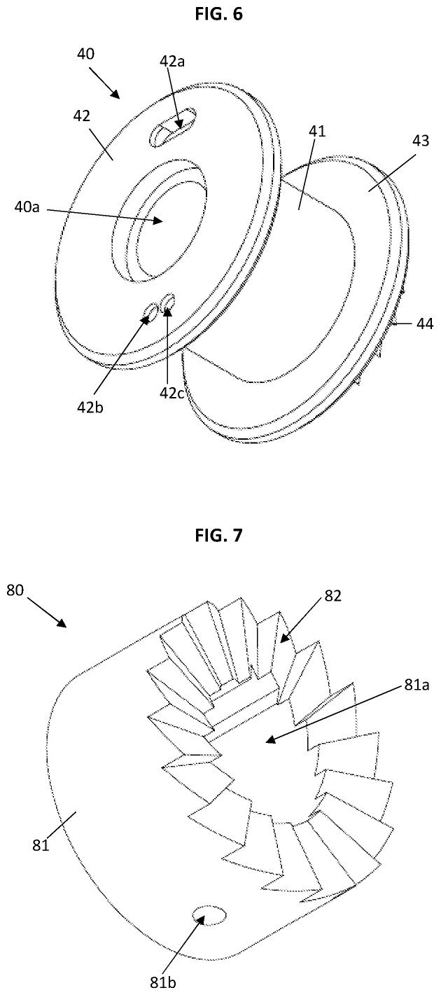

The first reel 40 is depicted in more detail in FIG. 6, which FIG. 6 is a perspective view of the first reel 40. In this embodiment, the second reel has a similar construction as the first reel, so that everything that will be described below with respect to the first reel may similarly apply to the second reel.

The first reel 40 comprises a cylindrical body 41 having a bore 40a extending through the cylindrical body 41 to rotatably receive the axle 30. A first flange 42 is provided at one end of the cylindrical body and a second flange 43 is provided at an opposite end of the cylindrical body to define a space in between the first and second flange 42, 43 to receive the first rope 60.

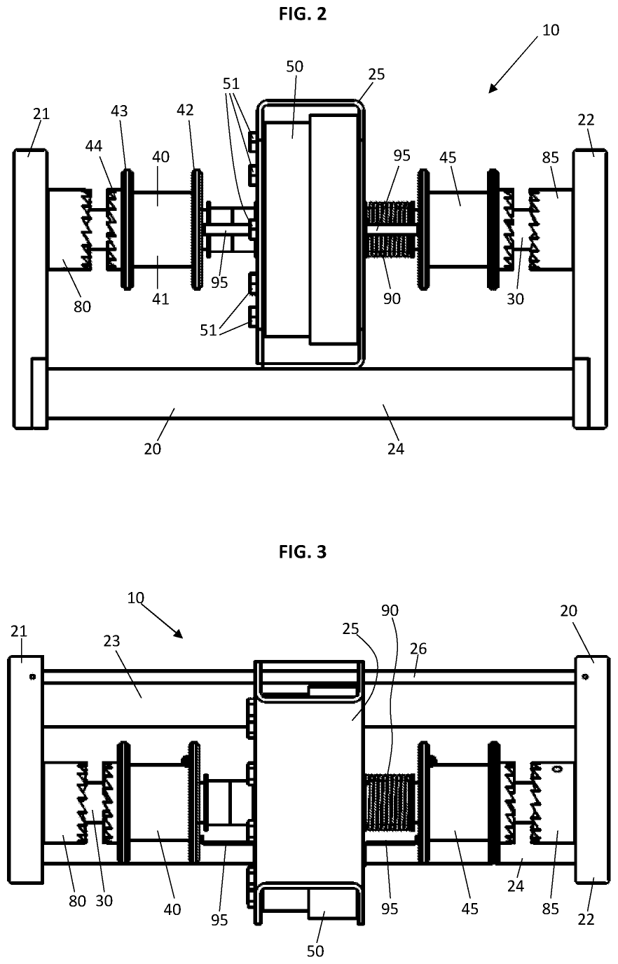

At a side of the second flange 43 facing away from the first flange 42, the first reel 40 is provided with a coupling element 44 allowing to couple with a similar coupling element 80 on the axle 30 as will be explained in more detail below. In FIG. 6 only a small portion of the coupling element 44 is visible, but reference is made to FIGS. 1 and 2 in which the coupling element 44 is better depicted.

As mentioned above, the coupling element 44 of the first reel 40 is configured to couple to a similar coupling element 80 on the axle 30. The corresponding coupling element of the second reel 45 is configured to couple to a similar coupling element 85 on the axle 30. The coupling element 80 is depicted in more detail in FIG. 7 and includes a ring-shaped body 81 having a bore 81a extending therethrough for receiving the axle 30. In this embodiment, a sidewall of the ring-shaped body 81 includes a hole 81b allowing to fix the coupling element 80 to the axle 30, e.g. by introducing a pin or screw or bolt into the axle 30 via the hole 81b. Any other fixation possibilities are also envisaged.

The coupling element 80 comprises a sawtooth pattern 82 at one end of the coupling element 80 that matches a sawtooth pattern on the coupling element 44 of the first reel. The sawtooth pattern ensures that once the coupling elements 44 and 80 engage with each other, a coupling is established such that rotation of the coupling element 80 (due to rotation of the axle 30) will also cause rotation of the first reel 40. The coupling element 85 for the second reel 45 is similar in design and function.

Due to the sawtooth pattern, the coupling between coupling element 44 and coupling element 80 in one rotational direction is stronger than in the other rotational direction. Preferably, the coupling is strong in the rotational direction corresponding to lowering a person, i.e. the rotational direction corresponding to paying out the first rope 60 so that the first reel is operatively connected to the brake 50 during lowering at all times. The weak connection is then preferably in the opposite rotational direction corresponding to hauling in the first rope, so that the first reel 40 is able to slip relative to the coupling element 80 when the load is above a predetermined value, thereby preventing a lowered person from inadvertently being lifted by the first reel and first rope when another person is lowered using the second reel and second rope, and/or preventing the first rope and possible a hook or attachment member connected to a free end of the first rope from damaging the rope-lowering device upon reaching the frame 20 when lowering of a person using the second rope and second reel continues as will be explained below in more detail. Again, the same applies to the coupling element 85 and the second reel 45.

Referring back to FIG. 6, the first flange 42 of the first reel 40 includes rope connecting holes 42b and 42c allowing to connect a free end of the first rope 60 to the first reel 40. The second reel 45 may have similar holes for connecting a free end of the second rope 70 to the second reel 45. The other free ends of the first rope 60 and the second rope 70 may be connected to a hook or other attachment member allowing a person to be suspended from the first and second rope. Alternatively, or additionally, it is possible that a harness is connected to the first and/or second rope. Of course, other connection principles to connect a rope to the reel as known in the art may be contemplated.

In the FIGS. 1-5, the first and second reel 40, 45 are both shown in their disconnected state. In the disconnected state of the first and second reel 40, 45, two elements may operate on the respective reels, namely a spring 90 and a retainer 95. The retainer 95 for the first reel 40 and the retainer 95 for the second reel 45 are shown in the FIGS. 1-3. The spring 90 is only depicted for the second reel 45 and omitted for the first reel 40 to show the retainer 95 more clearly for the first reel 40.

The spring 90 is provided between the brake housing 25 and the respective reel 40, 45 to urge the respective reel 40, 45 towards the respective coupling element 80, 85. Hence, the spring 90 urges the respective reel towards the connected state. The retainer 95 is provided between the brake housing 25 and the respective reel and is configured to temporarily retain the respective reel 40, 45 in the disconnected state. To this end, the first flange 42 of the first reel 40 comprises an opening 42a allowing to receive the retainer 95, which retainer includes a hook portion to engage with a shoulder in or at the opening 42a thereby being able to counteract the applied spring force of spring 90 and to retain the first reel. The second reel comprises a similar opening to cooperate with the other retainer 95.

The opening 42a in the first flange 42 of the first reel 40 may allow to rotate the first reel at least over a predetermined distance while being retained by the retainer 95 in a rotational direction corresponding to paying out the first rope. When the first reel 40 is rotated over the predetermined distance, the opening 42a is then preferably configured to move the hook portion of the retainer 95 to a position in which it is able to pass the opening 42a thereby allowing to release the first reel 40 from the retainer 95 by rotating the first reel 40 resulting in the first reel 40 being moved towards the connected state by bringing the coupling element 44 in engagement with the coupling element 80 using the spring 90. An advantage of the retainer 95 and the spring 90 is that the respective reel can be manually and automatically brought from the disconnected state to the connected state using passive elements. However, a solution in which active elements are used are of course also envisaged. The same applies of course for the second reel 45 and the spring 90 and the retainer 95 corresponding to the second reel 45.

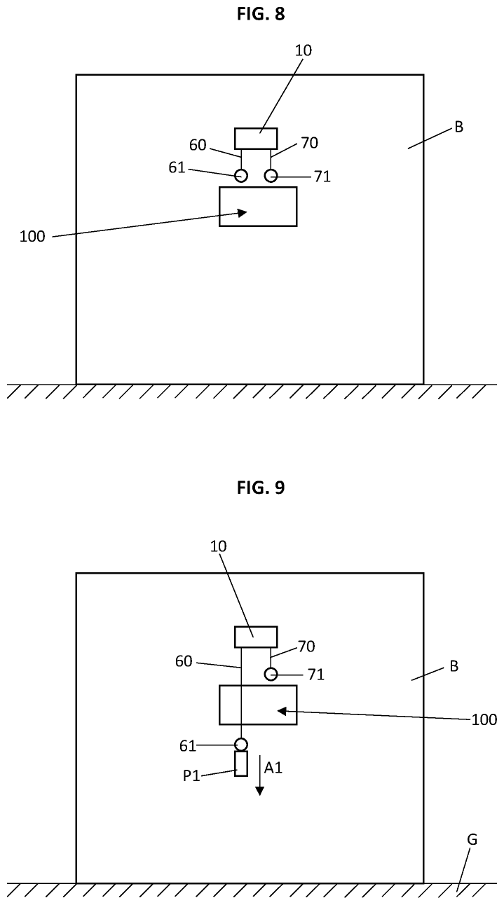

A method of use according to an embodiment of the invention and using the rope-lowering device 10 of FIG. 1 will be described below by reference to the FIGS. 8-12.

FIG. 8 schematically depicts a building B with a window or balcony 100 and above the window or balcony 100 the rope-lowering device 10 of FIG. 1. For ease of reference, the description below will continue as if the building has a window 100, but the skilled person will recognize that the same applies to a balcony 100.

The rope-lowering device 10 has an initial configuration in which the first rope 60 is wound on the first reel 40 for the most part and in which the second rope 70 is wound on the second reel 45 for the most part with the first and second reel 40, 45 being both in the disconnected state.

In this embodiment, an attachment member 61 is connected to a free end of the first rope 60 and an attachment member 71 is connected to a free end of the second rope 70. The attachment members 61 and 71 are preferably positioned such that in case of an emergency, an average adult, after opening the window or braking the glass of the window, is able to reach the attachment members 61, 71, possibly after using an aid such as a step, stair, chair or table.

In case of an emergency, a person may reach out to one of the attachment members 61, 72 to connect himself to the first or second rope 60, 70. During connecting of the person to the first or second rope, the respective rope may be paid out sufficiently to allow the release from the respective reel from the retainer 95 thereby bringing the respective reel in the connected state in which the respective reel is connected to the brake 50. However, bringing the respective reel in the connected state may also happen during the first stage of lowering described below.

FIG. 9 schematically depicts the building B, the window 100, the rope-lowering device 10 and a person P1. The person P1 has connected himself or herself to the attachment member 61 of the first rope 60 and has jumped out of the window 100. Gravitational forces acting on the person P1 will let him fall towards the ground G as indicated by arrow A1, but as the first reel 40 has been brought to the connected state, the brake is able to apply braking forces to the first rope 60 via the axle 30, the coupling element 80 and the first reel 40 that counteract the gravitational forces and limit the lowering speed of the person P1.

Because the second reel 45 is still in the disconnected state, the paying out of the first rope 60 and resulting rotation of the axle 30 does not affect the second reel 45 with the second rope 70.

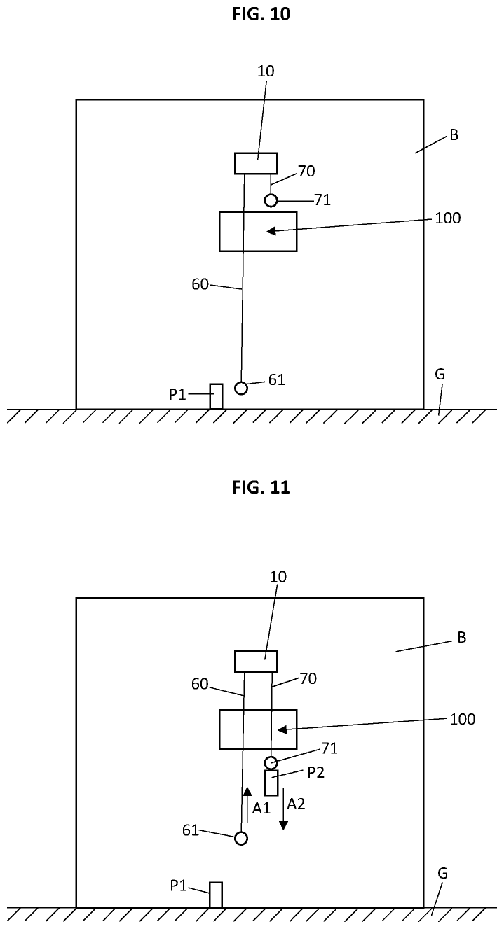

FIG. 10 schematically depicts the situation in which the first person P1 has reached the ground G and has disconnected himself from the attachment member 61. This allows a second person P2 (see FIG. 11) to connect himself to the attachment member 71. Preferably, during connecting of the second person P2 to the attachment member 71, the second reel 45 is released from the retainer 95 and moved to the connected state in which the second reel 45 is connected to the brake 50. In this situation, both the first reel 40 and the second reel 45 are connected to the brake 50.

FIG. 11 schematically depicts the situation in which the second person P2 is lowered to the ground as indicated by arrow A2. Due to the second rope 70 being connected to the brake 50 via the second reel 45, the coupling element 85 and the axle 30, the lowering speed of the second person P2 is limited by the brake 50 similarly as described above when the first person P1 was lowered to the ground G.

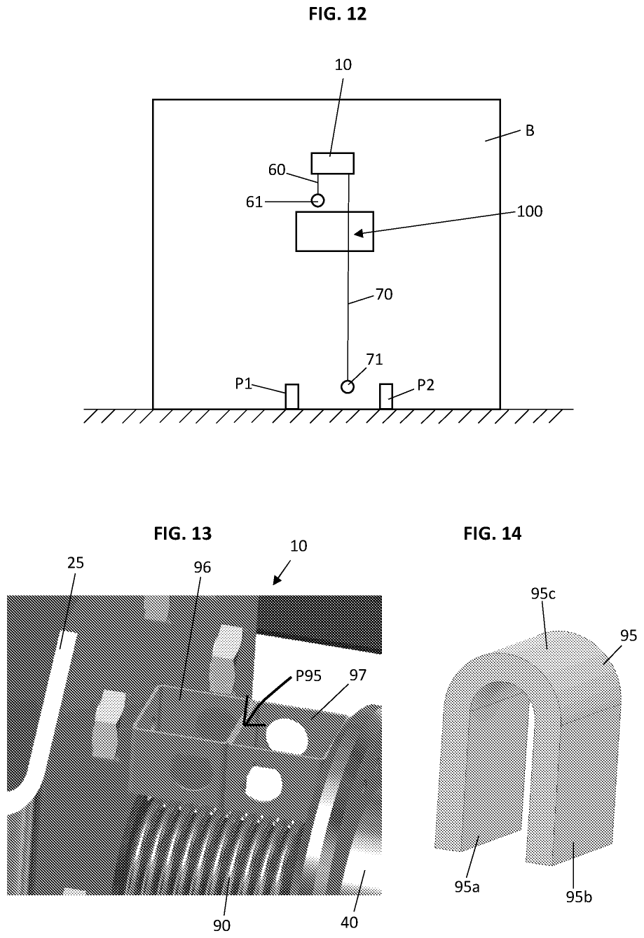

The rope-lowering device 10 is configured such that when both the first and second reels 40, 45 are connected to the axle 30, paying out one of the first and second rope 60, 70 will automatically cause the other one of the first and second rope 60, 70 to be hauled in. Hence, in the situation depicted in FIG. 11, paying out the second rope 70 will automatically haul in the first rope 60 as indicated by arrow A1. When the second person P2 reaches the ground G and disconnects himself from the attachment member 71, the attachment member 61 has reached the window 100 allowing a next person to use the first rope 60 to be lowered to the ground G as shown in FIG. 12. Lowering of person can now be continued by alternatingly using the first rope 60 and the second rope 70 until everybody has been lowered to the ground G.

A building B may of course be equipped with a plurality of rope-lowering devices 10 in order to increase the lowering capacity or to lower person from a higher level. In an embodiment, a person may have to use a first rope-lowering device to lower himself from a window 100 to a platform or balcony in between the window 100 and the ground G and subsequently may have to use a second rope-lowering device to lower himself from said platform or balcony to the ground G.

The sawtooth pattern on the coupling elements 44, 80 and 85 as described above may be advantageous in the situation of FIG. 10 when the second person P2 jumps out of the window 100 before the first person P1 was able to disconnect himself from the first rope 60. Because of the sawtooth pattern having a weak rotational coupling and a strong rotational coupling in the opposite direction, the first person P1 will not be lifted due to the lowering of the second person P2 as a result of the weak rotational coupling allowing the weight of the first person P1 to let the first reel 40 slip relative to the coupling element 80. A similar advantage may occur in the situation depicted in FIG. 12, when the first rope 60 and the attachment member 61 reach the frame and/or cover of the rope-lowering device 10. When the second person P2 would continue to pay out the second rope, the attachment member 61 may be brought into engagement of the frame and/or cover of the rope-lowering device thereby damaging the rope-lowering device or bringing the first rope 60 and attachment member 61 out of reach of a next person. The weak coupling between first reel and coupling element 80 will allow the first reel to slip relative to the coupling element thereby keeping the first rope and attachment member 61 within reach of the next person and/or preventing damage to the rope-lowering device 10.

Although the above embodiments describe the first and second reel 40, 45 to be moveable between a disconnected state and a connected state, the invention can also be carried out when the first and second reel 40, 45 only have a connected state, e.g. when they are connected using the sawtooth pattern having a strong and weak coupling in two opposite rotational directions. The second reel 45 may then slip relative to the coupling element 85 during the first lowering as depicted in FIG. 9.

FIG. 13 schematically depicts a rope-lowering device 10 according to another embodiment of the invention. The rope-lowering device 10 is similar to the embodiment described in FIGS. 1-5, but with a different principle of retaining a first or second reel in the disconnected state.

FIG. 13 depicts a brake housing 25, a first reel 40, and a spring 90 similar to the embodiment of FIGS. 1-5. Connected to the brake housing is a first member 96 and connected to the first reel 40 is a second member 97. The first and second member 96, 97 are in alignment in FIG. 13 and are in contact with each other or at least close to each other in a disconnected state of the first reel 40. To keep the first and second member 96, 97 close to each other and thus the first reel 40 in the disconnected state, a retainer 95 is provided as shown in FIG. 14.

The retainer 95 comprises a first leg 95a to be received in the first member 96 and a second leg 95b to be received in the second member 97, wherein the first leg 95a and the second leg 95b are connected to each other by bridging element 95c. Bridging element 95c not only holds the first leg 85a and the second leg 95b together, it also prevents the retainer 95 from falling from the first and/or second member 96, 97. The retainer 95 is to be inserted from above into location P95 as depicted in FIG. 13.

The retainer 95 will then prevent the spring 90 from pushing the first reel 40 into the connected state as described above in reference to FIGS. 1-5. To release the first reel 40 and allow the spring 90 to move the first reel 40 to the connected state, the retainer needs to be removed or broken, preferably at or near bridging element 95c.

To remove the retainer 95, the retainer 95 may be connected to a string that can be manually pulled to pull the retainer 95 away when needed.

Alternatively, or additionally, the retainer may be connected to the first rope would on the first reel 40, so that paying out the first rope will automatically pull the retainer 95 away.

In an embodiment, the second member 97 is attached to the first reel 40 such that the first reel is able to rotate while the second member 97 is maintained in the relative position relative to the first member as shown in FIG. 13 so that although the first reel 40 is rotating, the retainer 95 is still able to retain the first reel 40 in the disconnected state. This allows to remove the retainer 95 only after some significant rotation of the first reel 40.

Alternatively, or additionally, the bridging element 95c may be dimensioned or designed such that a predetermined load to the first reel will break the retainer 95 in two pieces so that it is no longer able to counteract the spring force applied by the spring 90.

The retainer 95 and the first and second members 96, 97 may be configured such that the retainer 95 is clamped relative to the first and second members 96, 97 so that a relatively small load or movement of the device will not easily move the retainer 95 causing an undesired release of the first reel 40.

The above has been described by reference to the first reel, but alternatively or additionally, this may also apply in a similar way to a second reel.

Although not shown, two bars or rods may extend between the two end members of the frame, with the first and second rope extending in the slit formed in between the two bars or rods. This slit may additionally or alternatively be provided in the cover. The slit may prevent the free ends of the first and second rope from being pulled on the first or second reel, respectively, but may also limit movement of the first and second rope in a direction perpendicular to the two bars or rods i.e. the slit. Additional element may also be provided to limit movement of the first and second ropes in a direction parallel to the two bars or rods, i.e. the slot.

The invention may be summarized by the following clauses:
1. A rope-lowering device (10) for lowering persons (P1, P2) from a building (B) or the like, comprising:
   an axle (30) arranged to rotate about its longitudinal axis (31);
   a first reel (40) connected or connectable to the axle;
   a second reel (45) connected or connectable to the axle;
   a brake (50) connected to the axle, which brake is configured to provide a braking force to the axle independent of a direction of rotation;
   a first rope (60) connected to the first reel to be suspended from the first reel; and
   a second rope (70) connected to the second reel to be suspended from the second reel,
   wherein the rope-lowering device is configured such that when both the first and second reels are connected to the axle, paying out one of the first and second rope will automatically cause the other one of the first and second rope to be hauled in.
2. A rope-lowering device according to clause 1, wherein the first reel has a disconnected state, in which the axle is free to rotate relative to the first reel, and a connected state, in which the first reel is connected to the axle to rotate along with the axle, wherein preferably a retainer (95) is provided to retain the first reel in the disconnected state, and wherein preferably a spring (90) is provided to move the first reel towards the connected state upon release from the retainer.
3. A rope-lowering device according to clause 2, wherein the first reel has a coupling element (44), wherein the axle has a coupling element (80) to couple with the coupling element of the first reel in the connected state, and wherein preferably the coupling element of the first reel and the corresponding coupling element on the axle are configured such that the coupling is stronger in a rotational direction corresponding to paying out the first rope than in the opposite rotational direction.
4. A rope-lowering device according to any of clauses 1-3, wherein the second reel has a disconnected state, in which the axle is free to rotate relative to the second reel, and a connected state, in which the second reel is connected to the axle to rotate along with the axle, wherein preferably a retainer (95) is provided to retain the second reel in the disconnected state, and wherein preferably a spring (90) is provided to move the second reel towards the connected state upon release from the retainer.
5. A rope-lowering device according to clause 4, wherein the second reel has a coupling element, wherein the axle has a coupling element (85) to couple with the coupling element of the second reel in the connected state, and wherein preferably the coupling element of the second reel and the corresponding coupling element on the axle are configured such that the coupling is stronger in a rotational direction corresponding to paying out the second rope than in the opposite rotational direction.
6. A method for lowering persons (P1, P2) from a building (B) or the like, wherein use is made of a rope-lowering device (10) according to clause 1, said method comprising the following steps:
   a. connecting a first person (P1) to the first rope (60);
   b. lowering the first person;
   c. disconnecting the first person from the first rope;
   d. connecting a second person (P2) to the second rope (70);
   e. lowering the second person; and
   f. disconnecting the second person from the second rope,
   wherein during step e. the first rope is automatically hauled in.
7. A method according to clause 6, further comprising the following steps:
   g. connecting a next person to the first or second rope previously hauled in;
   h. lowering the next person; and
   i. disconnecting the next person from said first or second rope,
   wherein during step h. the other one of the first and second rope is automatically hauled in, and wherein preferably the steps g. to i. are repeated until all persons have been lowered that need to be lowered.
8. A method according to clause 6 or 7, wherein use is made of a rope-lowering device according to clause 4, wherein prior to step a. the second reel is brought into the disconnected state, and wherein during step d. or e. the second reel is brought into the connected state.
9. A method according to clause 8, wherein use is made of a rope-lowering device according to clauses 2 and 4, wherein prior to step a. the first reel is brought into the disconnected state, and wherein during step a. or b. the first reel is brought into the connected state.
10. A method for refurbishing a rope-lowering device according to clause 1, said method comprising the step of winding the first and/or second rope on the respective first and/or second reel.
11. A method according to clause 10, wherein the rope-lowering device is a rope-lowering device according to clause 2, and wherein the method includes the step of providing the first reel in the disconnected state.
12. A method according to clause 10 or 11, wherein the rope-lowering device is a rope-lowering device according to clause 4, and wherein the method includes the step of providing the second reel in the disconnected state.

1. A rope-lowering device for lowering persons from a building or the like, comprising:
an axle arranged to rotate about its longitudinal axis;
a first reel connected or connectable to the axle;
a second reel connected or connectable to the axle;
a brake connected to the axle, which brake is configured to provide a braking force to the axle independent of a direction of rotation;
a first rope connected to the first reel to be suspended from the first reel; and
a second rope connected to the second reel to be suspended from the second reel,
wherein the rope-lowering device is configured such that when both the first and second reels are connected to the axle, paying out one of the first and second rope will automatically cause the other one of the first and second rope to be hauled in.

2. A rope-lowering device according to claim 1, wherein the first reel has a disconnected state, in which the axle is free to rotate relative to the first reel, and a connected state, in which the first reel is connected to the axle to rotate along with the axle, wherein preferably a retainer is provided to retain the first reel in the disconnected state, and wherein preferably a spring is provided to move the first reel towards the connected state upon release from the retainer.

3. A rope-lowering device according to claim 1, wherein the first reel has a coupling element, wherein the axle has a coupling element to couple with the coupling element of the first reel in a connected state, and wherein preferably the coupling element of the first reel and the corresponding coupling element on the axle are configured such that the coupling is stronger in a rotational direction corresponding to paying out the first rope than in the opposite rotational direction.

4. A rope-lowering device claim 1, wherein the second reel has a disconnected state, in which the axle is free to rotate relative to the second reel, and a connected state, in which the second reel is connected to the axle to rotate along with the axle, wherein preferably a retainer is provided to retain the second reel in the disconnected state, and wherein preferably a spring is provided to move the second reel towards the connected state upon release from the retainer.

5. A rope-lowering device claim 1, wherein the second reel has a coupling element, wherein the axle has a coupling element to couple with the coupling element of the second reel in a connected state, and wherein preferably the coupling element of the second reel and the corresponding coupling element on the axle are configured such that the coupling is stronger in a rotational direction corresponding to paying out the second rope than in the opposite rotational direction.

6. A rope-lowering device claim 1, wherein the brake is configured to apply an increasing braking force with increasing speed.

7. A rope-lowering device according to claim 6, wherein the brake is a centrifugal brake.

8. A rope-lowering device according to claim 6, wherein the brake is a rotary damper, e.g. a hydraulic rotary damper.

9. A rope-lowering device according to claim 2, wherein the retainer is releasable by rotating the respective reel over a predetermined angle.

10. A rope-lowering device according to claim 2, wherein the retainer is configured to be broken to release the respective reel.

11. A rope-lowering device according to claim 2, wherein the retainer is configured to be moved away to release the respective reel.

12. A method for lowering persons from a building or the like, wherein use is made of a rope-lowering device comprising:
an axle arranged to rotate about its longitudinal axis,
a first reel connected or connectable to the axle,
a second reel connected or connectable to the axle,
a brake connected to the axle, which brake is configured to provide a braking force to the axle independent of a direction of rotation,
a first rope connected to the first reel to be suspended from the first reel, and
a second rope connected to the second reel to be suspended from the second reel,
wherein the rope-lowering device is configured such that when both the first and second reels are connected to the axle, paying out one of the first and second rope will automatically cause the other one of the first and second rope to be hauled in,
and wherein said method comprising the following steps:
a. connecting a first person to the first rope;
b. lowering the first person;
c. disconnecting the first person from the first rope;
d. connecting a second person to the second rope;
e. lowering the second person; and
f. disconnecting the second person from the second rope,
wherein during step e. the first rope is automatically hauled in.

13. A method according to claim 12, further comprising the following steps:
g. connecting a next person to the first or second rope previously hauled in;
h. lowering the next person; and
i. disconnecting the next person from said first or second rope,
wherein during step h. the other one of the first and second rope is automatically hauled in, and wherein preferably the steps g. to i. are repeated until all persons have been lowered that need to be lowered.

14. A method according to claim 12, wherein use is made of a rope-lowering device in which the second reel has a disconnected state, in which the axle is free to rotate relative to the second reel, and a connected state, in which the second reel is connected to the axle to rotate along with the axle, wherein preferably a retainer is provided to retain the second reel in the disconnected state, wherein preferably a spring is provided to move the second reel towards the connected state upon release from the retainer, wherein prior to step a. the second reel is brought into the disconnected state, and wherein during step d. or e. the second reel is brought into the connected state.

15. A method according to claim 14, wherein use is made of a rope-lowering device in which the first reel has a disconnected state, in which the axle is free to rotate relative to the first reel, and a connected state, in which the first reel is connected to the axle to rotate along with the axle, wherein preferably a retainer is provided to retain the first reel in the disconnected state, wherein preferably a spring is provided to move the first reel towards the connected state upon release from the retainer, and in which the second reel has a disconnected state, in which the axle is free to rotate relative to the second reel, and a connected state, in which the second reel is connected to the axle to rotate along with the axle, wherein preferably a retainer is provided to retain the second reel in the disconnected state, wherein preferably a spring is provided to move the second reel towards the connected state upon release from the retainer, wherein prior to step a. the first reel is brought into the disconnected state, and wherein during step a. or b. the first reel is brought into the connected state.

16. A method for refurbishing a rope-lowering device comprising:
an axle arranged to rotate about its longitudinal axis,
a first reel connected or connectable to the axle,
a second reel connected or connectable to the axle,
a brake connected to the axle, which brake is configured to provide a braking force to the axle independent of a direction of rotation,
a first rope connected to the first reel to be suspended from the first reel, and
a second rope connected to the second reel to be suspended from the second reel,
wherein the rope-lowering device is configured such that when both the first and second reels are connected to the axle, paying out one of the first and second rope will automatically cause the other one of the first and second rope to be hauled in,
said method comprising the step of winding the first and/or second rope on the respective first and/or second reel.

17. A method according to claim 16, wherein the rope-lowering device is a rope-lowering device in which the second reel has a disconnected state, in which the axle is free to rotate relative to the second reel, and a connected state, in which the second reel is connected to the axle to rotate along with the axle, wherein preferably a retainer is provided to retain the second reel in the disconnected state, wherein preferably a spring is provided to move the second reel towards the connected state upon release from the retainer, and wherein the method includes the step of providing the first reel in the disconnected state.

18. A method according to claim 16, wherein the rope-lowering device is a rope-lowering device in which the first reel has a disconnected state, in which the axle is free to rotate relative to the first reel, and a connected state, in which the first reel is connected to the axle to rotate along with the axle, wherein preferably a retainer is provided to retain the first reel in the disconnected state, wherein preferably a spring is provided to move the first reel towards the connected state upon release from the retainer, and wherein the method includes the step of providing the second reel in the disconnected state.

19. A rope-lowering device according to claim 4, wherein the retainer is releasable by rotating the respective reel over a predetermined angle.

20. A rope-lowering device according to claim 4, wherein the retainer is configured to be broken to release the respective reel or to be moved away to release the respective reel.
